(19) United States
(12) Patent Application Publication
(10) Pub. No.: US 2025/0019587 A1
(43) Pub. Date: Jan. 16, 2025

(54) SURFACTANT COMPOSITION

(71) Applicant: NOURYON CHEMICALS INTERNATIONAL B.V., Amsterdam (NL)

(72) Inventors: Paul Michael Ferm, Morristown, NJ (US); Hans Peter Oskarsson, Stenungsund (SE); Michael Jeffrey Engel, Mount Kisco, NY (US); Kiernan Albert Heck, Pequannock, NJ (US)

(73) Assignee: NOURYON CHEMICALS INTERNATIONAL B.V., Amsterdam (NL)

(21) Appl. No.: 18/712,388

(22) PCT Filed: Nov. 23, 2022
(86) PCT No.: PCT/EP2022/082948

§ 371 Date: May 22, 2024

Related U.S. Application Data
(60) Provisional application No. 63/264,449, filed on Nov. 23, 2021.

(51) Int. Cl. C09K 8/60; C09K 8/68; E21B 43/27

(52) U.S. Cl. CPC C09K 8/602; C09K 8/68; E21B 43/27

(57) ABSTRACT

A surfactant composition includes a first surfactant and a second surfactant. The first surfactant has the following structure (I):

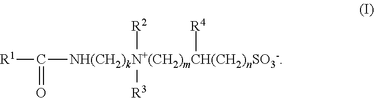

The second surfactant has the following structure (II):

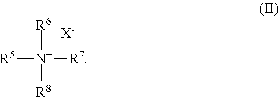

### CROSS-REFERENCE TO RELATED APPLICATIONS

This application is a U.S. National-Stage entry under 35 U.S.C. § 371 based on International Application No. PCT/EP2022/082948, filed Nov. 23, 2022, which was published under PCT Article 21(2) and which claims priority to U.S. Patent Application No. 63/264,449, filed Nov. 23, 2021, which are all hereby incorporated in their entirety by reference.

### TECHNICAL FIELD

The present disclosure generally relates to viscoelastic fluids used in the drilling, completion and stimulation of hydrocarbon-including formations. More specifically, the disclosure relates to viscoelastic fluids including two particular surfactants that provide superior and unexpected synergy relative to viscosifying in a variety of brines and across a variety of temperatures.

### BACKGROUND

Viscoelastic fluids can play very important roles in oilfield applications. The viscosity of such fluids allows them to carry particles from one place to another. For example, a drilling viscoelastic fluid is able to carry drilling cuts from a wellbore to a surface of a well. In another example, a viscoelastic fluid, or so-called “lost circulation” material, is used to seal borehole fractures thus preventing loss of drilling fluid into the formation materials.

Viscoelastic fluids can also play essential roles in gravel packing completion. In gravel pack operations, a steel screen is typically placed in a wellbore and a viscoelastic completion fluid can be used to place prepared gravel of a specific size in a surrounding annulus to minimize sand production.

Fracturing fluids are also required to be viscous. As is appreciated in the art, a hydraulic fracture is formed by pumping a fracturing fluid into a wellbore at a rate sufficient to increase pressure downhole that exceeds a pressure of the fracture gradient of the rock. The fracturing fluid typically includes a proppant, which keeps an induced hydraulic fracture open after the pressure is released. For this reason, it is important for the fracturing fluid to have enough viscosity to transport the proppant into the fracture.

Many different polymers have been used to make viscoelastic fluids. Recently, viscoelastic surfactants (VES) have been widely applied to oilfields in applications such as drilling, gravel packing, acidizing, and fracturing applications due to their non- or less-damaging characteristics. VES fluids tend to have excellent capacity to suspend and transport sand/proppant. VES fluids also have several distinctive advantages over polymer fluids. Unlike polymer fluids, the VES fluids tend to be solid free, which minimizes formation damage after breakage. However, many VES fluids are sensitive to highly concentrated brines. For example, VES fluids tend to not gel heavy brines or to produce a fluid viscosity that is stable in high temperature conditions. For this reason, VES fluids tend to have some limitations for drilling, completion and fracturing applications, especially for deep wells, because many deep wells have bottom hole temperatures of about 149° C. (˜300° F.) or more, and tend to require heavy fluids to balance well pressure and maintain control of the well.

It is known that several VES fluid packages, such as VES/low MW polymers, cationic/anionic surfactants, and VES/cosurfactants, can successfully viscosify moderate density brines such as CaCl2), CaBr₂ and NaBr brines. However, none work in heavy ZnBr₂ brines at temperatures above about 250° F. under normal dosage (e.g. less than or equal to about 6 vol % as received). ZnBr₂ brines and mixed brines made by ZnBr₂/CaBr₂/CaCl₂ tend to be used if a density of 15 ppg or higher is needed for deep wells to balance well pressures.

Methods are known in the art to increase a temperature range over which viscoelastic surfactants can perform. In particular, various chemistries have been disclosed which greatly expand operating temperatures, allow for stabilization, and also allow for winterization. Such technologies extend to higher temperatures by creating stronger intramolecular bonds between adjacent headgroups of the surfactants when oriented in worm-line micelle (WLM). This is thought to increase “scission temperature”, i.e. a thermodynamic temperature at which the WLMs are broken, by increasing the energy required to break micelles. The great benefit of these WLMs is that their segments are thermodynamically reversible and can reform and break many times. At each selected higher temperature, the scission rate increases. However, the headgroups of such technologies can form internal electrostatic bonds which tends to disable the WLM formation since many headgroups are essentially internally, cyclically bound.

Accordingly, there remains a problem that must be solved. Namely, lost circulation is a problem that require use of a product that diverts and viscosifies in a variety of brines at a variety of temperatures up to 250° F. or 300° F. and even up to 400° F. Also, there is a clear need for viscoelastic surfactants which can viscosify over a wide temperature interval and a wide range of electrolytes, or total dissolved solids, in order to be used in a variety of key oilfield applications including lost circulation, gravel-pack, and stimulation of sub-terranean formations (or oilfield applications). Although some technologies perform well in many brines, these technologies tend to fail in monovalent brines (e.g. NaCl and NaBr) and can have suppressed service temperatures in CaCl₂. Therefore, there remains an opportunity for improvement. Furthermore, other desirable features and characteristics of the present disclosure will become apparent from the subsequent detailed description of the disclosure and the appended claims, taken in conjunction with the accompanying drawings and this background of the disclosure.

### BRIEF SUMMARY

This disclosure provides a surfactant composition including:
A. a first surfactant having the following structure (I):

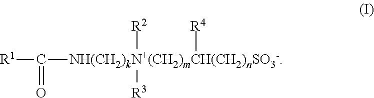

wherein R¹ is a saturated or unsaturated hydrocarbon group having from about 17 to about 29 carbon atoms,
wherein each of R² and R³ is independently a straight chain or branched, alkyl or hydroxyalkyl, group having from 1 to about 6 carbon atoms,
wherein R⁴ is chosen from H, a hydroxyl group, an alkyl group, and a hydroxyalkyl group, each group having from 1 to about 4 carbon atoms;
wherein k is from about 2 to about 20, m is from about 1 to about 20, and n is from about zero up to about 20; and
B. a second surfactant having the following structure (II):

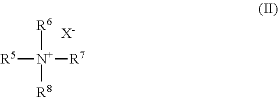

wherein R⁵ is an alkyl amine alkylene group, alkyl amido alkylene group, alkyl ether alkylene group, or alkyl ester alkylene group;
wherein each of R⁶ and R⁷ is independently an alkyl group, a hydroxy alkyl group, a polyalkoxy group having a degree of polymerization of from about 2 to about 30, a hydroxyl alkyl sulfonate group, an alkyl sulfonate group, or an alkylarylsulfonate group;
wherein R⁸ is a saturated or unsaturated alkyl group, aryl aralkyl group, or alkaryl group; or
wherein any two of R⁶, R⁷ and R⁸, together with the nitrogen atom to which each is attached form a heterocyclic ring; and
wherein X is chosen from halides, oxo ions of phosphorus, sulfur, or chloride, and organic anions.

### BRIEF DESCRIPTION OF THE DRAWINGS

The present disclosure will hereinafter be described in conjunction with the following drawing figures, wherein:

FIG. 1 is a line graph that shows a target line of 100 cP of viscosity and two curves, one for viscosity at 78 to 80° F. and one at 300° F. wherein various compositions can work at temperatures over this entire range; and

FIG. 2 is a line graph showing viscosity of various compositions during constant shearing at a rate of 100 s−1 and while a temperature is increased gradually from −70° F. to about 400° F.

### DETAILED DESCRIPTION

The following detailed description is merely exemplary in nature and is not intended to limit the current surfactant composition. Furthermore, there is no intention to be bound by any theory presented in the preceding background or the following detailed description. It is to be appreciated that all numerical values as provided herein, save for the actual examples, are approximate values with endpoints or particular values intended to be read as “about” or “approximately” the value as recited.

Embodiments of the present disclosure are generally directed to viscoelastic fluids and methods for forming the same. For the sake of brevity, conventional techniques related to viscoelastic fluids may not be described in detail herein. Moreover, the various tasks and process steps described herein may be incorporated into a more comprehensive procedure or process having additional steps or functionality not described in detail herein. In particular, various steps in the manufacture of viscoelastic fluids are well-known and so, in the interest of brevity, many conventional steps will only be mentioned briefly herein or will be omitted entirely without providing the well-known process details. In this disclosure, the terminology “about” can describe values ±0.1, 0.5, 1, 2, 3, 4, 5, 6, 7, 8, 9, or 10%, in various embodiments. Moreover, it is contemplated that, in various non-limiting embodiments, all values set forth herein may be alternatively described as approximate or “about.” Note that the subscript here for divalency is inferred in nomenclature, thus CaCl2) means CaCl₂ throughout this text, and so forth.

It is contemplated that all isomers and chiral options for each compound described herein are hereby expressly contemplated for use herein.

The present disclosure generally relates to surfactant compositions that may or may not form viscoelastic aqueous compositions (e.g. described hereinafter as various fluids such as fracturing fluids, drilling fluids, viscoelastic fluids, etc. or more generally “aqueous compositions”), and to methods of using such surfactant compositions. These surfactant compositions can usefully be employed in methods of stimulating and/or modifying the permeability of underground formations, in drilling fluids, completion fluids, workover fluids, acidizing fluids, gravel packing, fracturing, lost circulation fluids, and the like. Additionally, these surfactant compositions can also be employed in cleaning formulations, water-based coatings, detergent formulations, personal care formulations, water-based asphalt formulations and the like.

Viscoelasticity is a desirable rheological feature in drilling fluids, workover or completion fluids, and stimulation fluids which can be provided by fluid modifying agents such as polymeric agents and surfactant gelling agents. The terminology “viscoelastic” means that the fluids are those which exhibit both elastic behavior and viscous behavior, as is recognized and understood by those of skill in the art. Elasticity is typically defined as an instant strain (deformation) response of a material to an applied stress. Once the stress is removed, the material returns to its undeformed equilibrium state. This type of behavior is associated with solids. On the other hand, viscous behavior is typically defined as a continuous deformation resulting from an applied stress. Over time, a deformation rate (e.g. shear rate or strain rate) becomes steady. Once the stress is removed, the material does not return to its initial undeformed state. This type of behavior is associated with liquids. Viscoelastic fluids may behave as viscous fluids or elastic solids, or a combination of both depending upon the applied stress on the system and the time scale of the observation. Viscoelastic fluids can exhibit an elastic response immediately after stress is applied. After an initial elastic response, the strain relaxes and the viscoelastic fluid tends to start to flow in a viscous manner. The elastic behavior is believed to aid significantly in the transport of solid particles.

The viscosity of a viscoelastic fluid may also vary with the stress or rate of strain applied. In the case of shear deformations, it is very common that the viscosity of a viscoelastic fluid drops with increasing shear rate or shear stress. This behavior is usually referred to as “shear thinning”. Viscoelasticity in viscoelastic fluid that is caused by surfactants can manifest itself as shear thinning behavior. For example, when such a viscoelastic fluid is passed through a pump or is in the vicinity of a rotating drill bit, the viscoelastic fluid is in a high shear rate environment and the viscosity is low, resulting in low friction pressures and pumping energy savings. When the shearing stress is abated, the viscoelastic fluid returns to a higher viscosity condition. This is because the viscoelastic behavior is caused by surfactant aggregations. These aggregations will adjust to the conditions of the viscoelastic fluid, and will form different aggregate shapes under different shear stresses. Thus, one can have a viscoelastic fluid that behaves as a high viscosity fluid under low shear rates, and a low viscosity fluid under higher shear rates. High low shear-rate viscosities are good for solids transport.

The elastic component of a viscoelastic fluid may also manifest itself in a yield stress value. This allows a viscoelastic fluid to suspend an insoluble material, for example sand or drill cuttings, for a greater time period than a viscous fluid of the same apparent viscosity. Yield stresses that are too high are not typically useful in drilling, as it may make restarting the drilling bit very difficult and cause a condition known as “stuck pipe”.

Another function of viscoelastic fluids in oil drilling applications is in permeability modification. Secondary recovery of oil from reservoirs involves supplementing by artificial means the natural energy inherent in the reservoir to recover the oil. For example, when oil is stored in a porous rock it is often recovered by driving a pressurized fluid, such as brine, through one or more drill holes (injecting wells) into the reservoir formation to force the oil to a well bore from which it can be recovered. However, rock often has areas of high and low permeability. The brine injected can finger its way through the high permeability areas leaving unrecovered oil in the low permeability areas.

In various embodiments, the present disclosure relates to a surfactant composition and its use in aqueous compositions including high-density brines, specifically to create viscoelastic fluids that exhibit significantly improved viscosity at elevated temperatures up to 250° F., up to 300° F., up to 350° F., and in some cases up to 400° F. Additionally, such high-temperature stable VES fluids are provided that simultaneously provide significantly improved viscosity at so-called ambient temperatures, including temperatures down to 80° F. or temperatures down to 70° F., 60° F., and 50° F.

### Surfactant Composition:

This disclosure provides a surfactant composition, which can be used to create a viscoelastic fluid. However, the surfactant composition need not create a viscoelastic fluid in all embodiments.

The surfactant composition includes:
A. a first surfactant having the following structure (I):

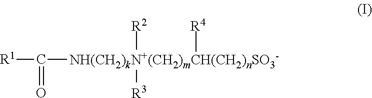

wherein R¹ is a saturated or unsaturated hydrocarbon group having from about 17 to about 29 carbon atoms,
wherein each of R² and R³ is independently a straight chain or branched, alkyl or hydroxyalkyl, group having from 1 to about 6 carbon atoms,
wherein R⁴ is chosen from H, a hydroxyl group, an alkyl group, and a hydroxyalkyl group, each group having from 1 to about 4 carbon atoms;
wherein k is from about 2 to about 20, m is from about 1 to about 20, and n is from about zero up to about 20; and
B. a second surfactant having the following structure (II):

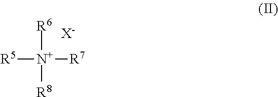

wherein R⁵ is an alkyl amine alkylene group, alkyl amido alkylene group, alkyl ether alkylene group, or alkyl ester alkylene group;
wherein each of R⁶ and R⁷ is independently an alkyl group, a hydroxy alkyl group, a polyalkoxy group having a degree of polymerization of from about 2 to about 30, a hydroxyl alkyl sulfonate group, an alkyl sulfonate group, or an alkylarylsulfonate group;
wherein R⁸ is a saturated or unsaturated alkyl group, aryl aralkyl group, or alkaryl group; or
wherein any two of R⁶, R⁷ and R⁸, together with the nitrogen atom to which each is attached form a heterocyclic ring; and
wherein X is chosen from halides, oxo ions of phosphorus, sulfur, or chloride, and organic anions.

It is also contemplated that the surfactant composition may include or be free of any one or more optional components described below. Alternatively, the surfactant composition may consist essentially of the first and second surfactants, and further consist essentially of, or be free of, any one or more optional components described below. It is also contemplated that the surfactant composition may be or consist of the first and second surfactants. It is also contemplated that the surfactant composition may be or consist of the first and second surfactants and any one or more optional components described below. In various embodiments, the terminology “consists essentially of” may describe embodiments that are free of one or more surfactants that are not the first and second surfactants described herein, and/or one or more solvents that may or may not be described herein, and/or one or more polymers that may or may not be described herein, and/or one or more proppants that may or may not be described herein, and/or one or more acids and/or bases that may or may not be described herein, and/or one or more additives that may or may not be described herein. It is contemplated that one or more first surfactants and one or more second surfactants may be utilized. Moreover, one or more additional surfactants may be used or may be excluded from use.

### First Surfactant:

The first surfactant has the following structure (I):

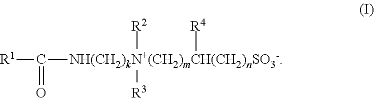

In the first surfactant, R¹ is a saturated or unsaturated hydrocarbon group having from about 17 to about 29 carbon atoms. In various embodiments, the number of carbon atoms is from about 18 to about 28, about 19 to about 27, about 20 to about 26, about 21 to about 25, about 22 to about 24, about 24 to about 24, or about 17, 18, 19, 20, 21, 22, 23, 24, 25, 26, 27, 28, or 29. In various embodiments, the number of carbon atoms is about 18 to about 21 or about 19 to about 20. In another embodiment R¹ is a fatty aliphatic derived from natural fats or oils having an iodine value of from about 1 to about 140, in another embodiment from about 30 to about 90, and in still another embodiment from about 40 to about 70. R¹ may be restricted to a single chain length or may be of mixed chain length such as those groups derived from natural fats and oils or petroleum stocks. Typical examples include, but are not limited to, tallow alkyl, hardened tallow alkyl, rapeseed alkyl, hardened rapeseed alkyl, tall oil alkyl, hardened tall oil alkyl, coco alkyl, oleyl, erucyl or soya alkyl. In various non-limiting embodiments, all values and ranges of values including and between those set forth above are expressly contemplated for use herein.

Moreover, each of R² and R³ is independently a straight chain or branched, alkyl or hydroxyalkyl, group having from 1 to about 6 carbon atoms. In various embodiments, this value is about 2 to about 5 or about 3 to about 4 or about 1, 2, 3, 4, 5, or 6. In various non-limiting embodiments, all values and ranges of values including and between those set forth above are expressly contemplated for use herein.

In addition, R⁴ is chosen from H, a hydroxyl group, an alkyl group, and a hydroxyalkyl group, each group having from 1 to about 4 carbon atoms. In various embodiments, this value is about 2 to about 3 or about 1, 2, 3, or 4. In various embodiments, R⁴ is typically ethyl, hydroxyethyl, OH or methyl. In one embodiment, R⁴ is H. In another embodiment, R⁴ is a hydroxyl group. In another embodiment, R⁴ is an alkyl group. In another embodiment, R⁴ is a hydroxyalkyl group. In various non-limiting embodiments, all values and ranges of values including and between those set forth above are expressly contemplated for use herein.

Furthermore, k is from about 2 to about 20. In various embodiments, k is about 3 to about 19, about 4 to about 18, about 5 to about 17, about 6 to about 16, about 7 to about 15, about 8 to about 14, about 9 to about 13, about 10 to about 12, or about 11 to about 12. In other embodiments, k is about 2, 3, 4, 5, 6, 7, 8, 9, 10, 11, 12, 13, 14, 15, 16, 17, 18, 19, or 20. In various non-limiting embodiments, all values and ranges of values including and between those set forth above are expressly contemplated for use herein.

Moreover, m is about 1 to about 20. In various embodiments, m is about 2 to about 19, about 3 to about 19, about 4 to about 18, about 5 to about 17, about 6 to about 16, about 7 to about 15, about 8 to about 14, about 9 to about 13, about 10 to about 12, or about 11 to about 12. In other embodiments, m is about 1, 2, 3, 4, 5, 6, 7, 8, 9, 10, 11, 12, 13, 14, 15, 16, 17, 18, 19, or 20. In various non-limiting embodiments, all values and ranges of values including and between those set forth above are expressly contemplated for use herein.

Still further, n is about 0 to about 20. In various embodiments, n is about 1 to about 20, about 2 to about 19, about 3 to about 19, about 4 to about 18, about 5 to about 17, about 6 to about 16, about 7 to about 15, about 8 to about 14, about 9 to about 13, about 10 to about 12, or about 11 to about 12. In other embodiments, n is about 0, 1, 2, 3, 4, 5, 6, 7, 8, 9, 10, 11, 12, 13, 14, 15, 16, 17, 18, 19, or 20. In various non-limiting embodiments, all values and ranges of values including and between those set forth above are expressly contemplated for use herein.

In various embodiments, R¹ is a C₂₂ group, each of R², R³, and R⁴ are methyl groups, and k is about 3.

The first surfactant may have general structure (I) and include an R¹ group derived from a natural product rich in erucic acid and may be referred to by this enriched ingredient. This one embodiment may be referred to by the most predominant combination of species where R¹ is erucyl, k is 3, R² and R³ are methyl, R⁴ is hydroxyl, and m and n are 1 and the molecule is typically called (Z)-3-((3-(docos-13-enamido)propyl)dimethylammonio)-2-hydroxypropane-1-sulfonate, referred to as (IA), with the following structure:

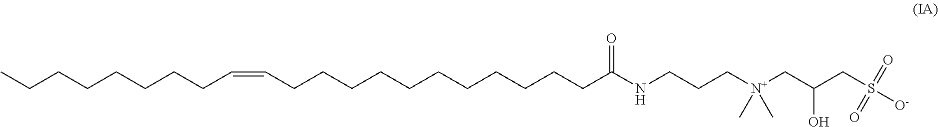 [SMILES: CCCCCCCC/C=C\CCCCCCCCCCCC(=O)NCCC[N+](C)(C)CC(O)CS(=O)(=O)[O-]]

This structure can also more generally be referred to erucamidopropyl hydroxypropylsultaine.

In various embodiments, the first surfactant is present in the surfactant composition in an amount of from about 15 to about 60, about 20 to about 50, about 25 to about 40, about 28 to about 36, or about 31 to about 33, or at about 32 weight percent actives based on a total weight of the surfactant composition. In various non-limiting embodiments, all values and ranges of values including and between those set forth above are expressly contemplated for use herein.

In various embodiments, the first surfactant such as described broadly as Type I or IA above can be adjusted to various levels of pH from about pH 3 to about pH 9. The pH of a surfactant composition or an aqueous composition including such a first surfactant can thus have a pH of about 3, 4, 5, 6, 7, 8, or 9. In the case when pH is adjusted with HCl acid or NaOH caustic, the counterions introduced would be Na⁺ and Cl⁻, and so forth with other pH adjusting acids and bases.

### Second Surfactant:

The second surfactant has the following structure (II):

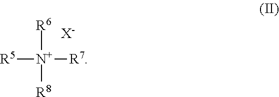

In this structure, R⁵ is an alkyl amine alkylene group, alkyl amido alkylene group, alkyl ether alkylene group, or alkyl ester alkylene group. In one embodiment, R⁵ is an alkyl amine alkylene group. In another embodiment, R⁵ is an alkyl amido alkylene group. In another embodiment, R⁵ is an alkyl ether alkylene group. In another embodiment, R⁵ is an alkyl ester alkylene group.

In various embodiments, the alkyl group of R⁵ is a saturated or unsaturated, hydrocarbon group of from about 1 to about 26 carbon atoms. In various embodiments, the number of carbon atoms is about 2 to about 25, about 3 to about 24, about 4 to about 23, about 5 to about 22, about 6 to about 21, about 7 to about 20, about 8 to about 19, about 9 to about 18, about 10 to about 17, about 11 to about 16, about 12 to about 15, about 13 to about 14, about 12 to about 14, about 14 to about 16, about 16 to about 18, about 18 to about 20, about 12 to about 20, about 12 to about 18, about 12 to about 16, etc. In other embodiments, the number of carbon atoms is 1, 2, 3, 4, 5, 6, 7, 8, 9, 10, 11, 12, 13, 14, 15, 16, 17, 18, 19, 20, 21, 22, 23, 24, 25, or 26. The number of carbon atoms described above may describe the number of carbon atoms in any one or more groups described above independently of one another. R⁵ may be linear, branched, or cyclic and all isomers of such groups are hereby expressly contemplated for use herein in various non-limiting embodiments. In various non-limiting embodiments, all values and ranges of values including and between those set forth above are expressly contemplated for use herein.

Moreover, in this structure, each of R⁶ and R⁷ is independently an alkyl group, a hydroxy alkyl group, a polyalkoxy group having a degree of polymerization of from about 2 to about 30, a hydroxyl alkyl sulfonate group, an alkyl sulfonate group, or an alkylarylsulfonate group. In various embodiments, the degree of polymerization is from about 3 to about 29, about 4 to about 28, about 5 to about 27, about 6 to about 26, about 7 to about 25, about 8 to about 24, about 9 to about 23, about 10 to about 22, about 11 to about 21, about 12 to about 20, about 13 to about 19, about 14 to about 18, about 15 to about 17, or about 16 to about 17. Moreover, R¹ is a saturated or unsaturated alkyl group, aryl aralkyl group, or alkaryl group. It is also contemplated that any two of R⁶, R⁷ and R⁸, together with the nitrogen atom to which each is attached can form a heterocyclic ring that may include 2 to 5 carbon atoms (e.g. 2, 3, 4, or 5 carbon atoms) and 1 to 6 heteroatoms (e.g. 1, 2, 3, 4, 5, or 6 heteroatoms) such as sulfur (S), nitrogen (N), oxygen (O) or silicon (Si) atoms. The number of carbon atoms and/or heteroatoms of any one or more of R⁶, R⁷ and R⁸ may alternatively and independently be as described above relative to R⁵. Similarly, any one or more of R⁶, R⁷ and R¹ may independently be or include a saturated or unsaturated hydrocarbon group that may be linear, branched, or cyclic and all isomers of such groups are hereby expressly contemplated for use herein in various non-limiting embodiments.

In various embodiments, R⁵ is an alkyl amine alkylene group or alkyl amido alkylene group, and/or R⁶ and R⁷ are each independently alkyl or hydroxy alkyl. Examples of suitable alkyl groups, R⁶, R⁷ or R⁸ include methyl, ethyl, propyl, butyl, hexyl, allyl, benzyl, vinyl benzyl, and the like, including iso-propyl, iso-butyl, sec-butyl, tert-butyl, and so forth. Examples of suitable hydroxy alkyl groups include 2-hydroxyethyl-2-hydroxypropyl and 2,3-dihydroxypropyl. Non-limiting examples of heterocyclic rings which may be formed by combination of two of R⁶, R⁷ and R⁸ include morpholine, piperidine, piperazine, and so forth. In various embodiments, polyalkoxy groups are ethyl, propyl or butyl. In still other examples, each of R⁶, R⁷ and R⁸ may be interchanged with each other so that any one or more of R⁶, R⁷ and R⁸ may be any other of R⁶, R⁷ and R⁸ that is described above.

In various embodiments, X is chosen from halides, oxo ions of phosphorus, sulfur, or chloride, and organic anions. It is contemplated that any known halide may be utilized. Similarly, any known organic anion may be utilized. In various embodiments, X may be halides; oxo ions of phosphorous, sulfur or chloride; and various organic anions, including chlorides, bromides, iodides, oxides of phosphorous, hypochlorides, phosphates, phosphites, oxides of sulfur, sulfates, sulfites, sulfonates, phosphates, acetates, carboxylates, chlorates, perchlorates, salicylates, phthalates, lactates, maleates, glycinates, citrates, citric acid, lactic acid, salicylic acid, salicylic acid, phthalic acid, benzoic acid, naphthoic acid, amino acids, etc.

In various embodiments, the second surfactant has one of the following structures,

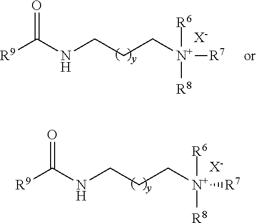

wherein each of R⁶, R⁷ and R⁸ may be any described above. In addition, all isomers and chiral options are hereby expressly contemplated for use herein. Moreover, R⁹ may be a saturated or unsaturated alkyl group having from about 1 to about 30 carbon atoms, typically from about 6 to about 26 carbon atoms and most typically from about 12 to about 22 carbon atoms. In various embodiments, the number of carbon atoms is about 1 to about 30, about 2 to about 25, about 3 to about 24, about 4 to about 23, about 5 to about 22, about 6 to about 21, about 7 to about 20, about 8 to about 19, about 9 to about 18, about 10 to about 17, about 11 to about 16, about 12 to about 15, about 13 to about 14, about 12 to about 14, about 14 to about 16, about 16 to about 18, about 18 to about 20, about 12 to about 20, about 12 to about 18, about 12 to about 16, etc. In other embodiments, the number of carbon atoms is 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30. In various non-limiting embodiments, all values and ranges of values including and between those set forth above are expressly contemplated for use herein.

In various embodiments, the second surfactant such as described broadly as Type II above can be adjusted to various levels of pH from about pH 3 to about pH 9. The pH of a surfactant composition or an aqueous composition including such a second surfactant can thus have a pH of about 3, 4, 5, 6, 7, 8, or 9. In the case when pH is adjusted with HCl acid, the counterion introduced would be Cl⁻, and so forth with other pH adjusting acids and bases.

In various embodiments, R⁹ may be a coco, palmityl, stearyl, oleyl, or erucyl, group. For example, R⁹ may be derived from a fatty acid. In various embodiments, a fatty carboxylic acid is reacted with an amine to form an amide. The long chain alkyl groups of R⁹ may be derived from the fatty acids and include cetyl, oleyl, stearyl, erucyl, and the derivatives of tallow, coco, soya and rapeseed oils. In other embodiments, a higher number of carbon atoms in R⁹ contributes to improved gelling. Moreover, R⁹ may be linear, branched, or cyclic and all isomers of such groups are hereby expressly contemplated for use herein in various non-limiting embodiments.

In other embodiments, y is from about 0 to about 12, about 1 to about 12, about 2 to about 11, about 3 to about 10, about 4 to about 9, about 5 to about 8, or about 6 to about 7. In other embodiments, y is about 1, 2, 3, 4, 5, 6, 7, 8, 9, 10, 11, or 12. Moreover, X may be as described above. In various non-limiting embodiments, all values and ranges of values including and between those set forth above are expressly contemplated for use herein. In one embodiment, y is 1, X is chloride, R is erucyl, and each of R⁶, R⁷ and R⁸ are methyl. In various embodiments, the second surfactant is obtained by quaternization of a alkylamidopropyldimethyl amine with one or more of methyl chloride, ethyl chloride, benzyl chloride, vinyl chloride, butyl chloride, methyl sulfate, chlorohydroxyalkylsulfonate, chloroalkylsulfonates, or combinations thereof. In a further embodiment, the second surfactant is erucyl amidopropyltrimethyl ammonium quaternary salt. In yet another embodiment, the second surfactant is an amidopropylmorpholine quaternary salt having the following general structure:

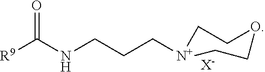

One specific surfactant of this particular structure is isosterylamidopropylmorpholine lactate.

Other non-limiting examples of the second surfactant include any one or more of the following:

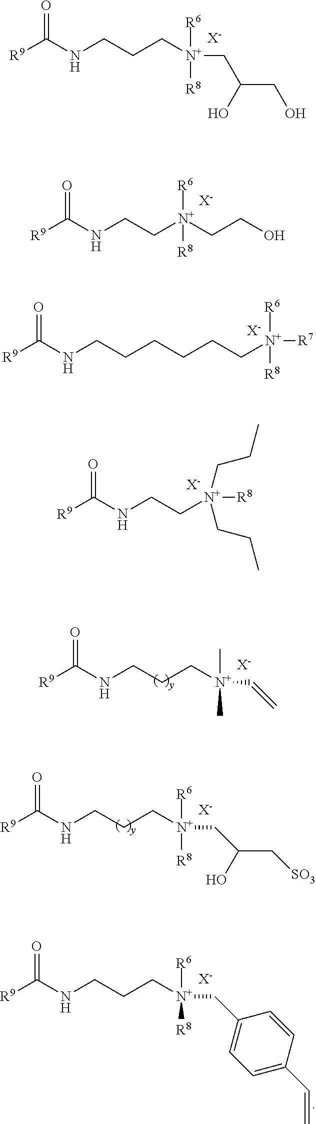

In other embodiments, the second surfactant has the following general structure (III):

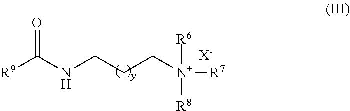

wherein R⁹ is a saturated or unsaturated alkyl group and y is from about 1 to about 12. In various non-limiting embodiments, all values and ranges of values including and between those set forth above are expressly contemplated for use herein.

One example of the second surfactant of general structure (III) includes an R⁹ group derived from a natural product rich in erucic acid and can be referred to by this enriched ingredient. This one embodiment may be referred to by the most predominant combination of species wherein R9 is erucyl, y is 3, R⁶, R⁷, and R⁸ are methyl and the molecule is typically called (Z)-3-(docos-13-enamido)-N,N,N-trimethylpropan-1-aminium, referred to as (IIIA), having the following structure:

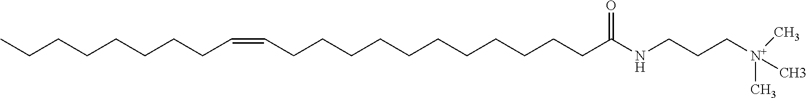 [SMILES: CCCCCCCC/C=C\CCCCCCCCCCCC(=O)NCCC[N+](C)(C)C]

This structure can also more generally be referred to erucamidopropyl trimethyl ammonium with various possible counterions noted, such as chloride.

In various embodiments, the second surfactant is present in an amount of from about 3 to about 40, about 5 to about 35, about 7 to about 30, about 10 to about 20, or about 13 to about 15 or at about 14 weight percent actives based on a total weight of the surfactant composition. In various non-limiting embodiments, all values and ranges of values including and between those set forth above are expressly contemplated for use herein.

In other embodiments, the weight ratio of actives of the first surfactant to the second surfactant is from about 0.4 to about 20, about 0.6 to about 10, about 0.8 to about 6, about 1.5 to about 3.5, about 2 to about 3, about 2.1 to about 2.6, or about 2.1 to about 2.4, or about 2.3. In various non-limiting embodiments, all values and ranges of values including and between those set forth above are expressly contemplated for use herein.

In various embodiments, the surfactant composition may include one or more solvents. The relative quantities and order of addition of solvents may be important to prevent premature gelling, to dissolve salts for a filtration free process, to prevent formation of a small upper ethanol phase, and/or to minimize melting point. In various embodiments, a glycol, e.g. propylene glycol, may be added to avoid premature gelling, e.g. in an amount of from about 7, 8, 9, 10, 11, 12, 13, 14, or 15, wt %, based on a total weight of the surfactant composition. In other embodiments, a second solvent, e.g. ethanol or isopropanol, is utilized in an amount of about 16, 17, 18, 19, 20, 21, or 22, 23, 24, 25 wt %, based on a total weight of the surfactant composition. In various non-limiting embodiments, all values and ranges of values including and between those set forth above are expressly contemplated for use herein.

In other embodiments, a total weight % isopropanol (and/or ethanol)+propylene glycol is from about 20 to about 40, about 30 to about 35, or about, 31, 32, 33, 34, or 35, wt %, based on a total weight of the surfactant composition. A weight to weight ratio range of ethanol to propylene glycol can vary from about 1.0 to about 2.2 to minimize gelling and formation of an upper ethanol liquid phase. The total amount of water is calculated by difference but should be noted is required to limit precipitation of water-soluble solids. Embodiments include water weight % of 3, 4, 5, 6, 7, 8, 9, 10, 11, 12, 13, 14, 15, 16, 17, 18, 19, 20, 21, 22 23, 24, 25, 26, 27, 28, 29, or 30. In various embodiments, the water weight % can range from 3% to 50%. In various non-limiting embodiments, all values and ranges of values including and between those set forth above are expressly contemplated for use herein.

### Aqueous Composition:

The surfactant compositions described above may be used as a component in an aqueous composition that may be thickened or gelled or may have the ability to thicken or gel. In various embodiments, the surfactant composition is present in the aqueous composition in an amount of from about 0.5 to about 15, about 1 to about 10, about 3 to about 8, about 5 to about 7, or about 6 weight percent actives based on a total weight of the aqueous composition. In various non-limiting embodiments, all values and ranges of values including and between those set forth above are expressly contemplated for use herein.

In various embodiments, the aqueous composition includes water and the surfactant composition described above. The water may be of any type and may be added independently from one or more of the first and second surfactants or may be added concurrently with, or as part of, one or more of the first and second surfactants. In various embodiments, water is present in the aqueous composition in an amount of from about 15 to about 25, about 15 to about 20, or about 20 to about 25, weight percent based on a total weight of the aqueous composition. In various non-limiting embodiments, all values and ranges of values including and between those set forth above are expressly contemplated for use herein.

The aqueous composition may also include, or be free of, one or more solvents. For example, a first solvent may be a di-hydric, or polyhydric alcohol, which can be oligomeric, or polymeric. Examples include, but are not limited to ethylene glycol, butylene glycol, diethylene glycol, polypropylene glycol, polyethylene glycol, glycerin, propylene glycol, tetramethylene glycol, tetramethylethylene glycol, trimethylene glycol, and the like. Propylene glycol (e.g., 1,2 propanediol) are typical glycols. A second solvent may be an alcohol, e.g. monohydric alcohols, alkanols or alcohol alkoxylates. Methanol, ethanol, and butanol are non-limiting examples. In various embodiments, solvents (apart from water) may be present in the aqueous composition in an amount of from about 1 to about 50, about to about 45, about 10 to about 40, about 15 to about 35, about 20 to about 30, about 25 to about 30, about 1 to about 10, about 2 to about 9, about 3 to about 8, about 4 to about 7, about 5 to about 6, about 15 to about 30, about 15 to about 25, about 15 to about 20, or about 20 to about 25, weight percent actives based on a total weight of the aqueous composition. In various non-limiting embodiments, all values and ranges of values including and between those set forth above are expressly contemplated for use herein.

In still other embodiments, a weight of water is based on a total weight of the aqueous composition. In other embodiments, a minimum water content is utilized to ensure that all salts are dissolved. In various embodiments, a weight to weight ratio range of ethanol to water is typically from about 1.0 to about 1.175 In various non-limiting embodiments, all values and ranges of values including and between those set forth above are expressly contemplated for use herein.

In various embodiments, the aqueous composition may be described as a brine. High density brines for oilfield use are usually made from (include) salts of divalent cations such as calcium and zinc. Brines including potassium, ammonium, sodium, cesium and the like may be used as well. Organic cations such as tetramethylammonium can also be employed. Typical inorganic anions for high density brines are chloride and bromide. In various embodiments, the brine is formed using alkali metal salts, alkaline earth metal salts, and/or ammonium salt), and may include viscosity modifying additives such as cellulosics). Brines gelled with such agents may be advantageously used as water diversion agents, pusher fluids, fracture fluids, drilling muds, gravel-packing fluids, drill-in fluids, workover fluids, completion fluids, and the like.

Organic anions such as formate and acetate may be used. Some combinations of these anions and cations may be used to give higher density brines. The selection of one salt over the other or two salts over single salt typically depends on environmental factors. For example, a single salt fluid may work during the heat of the summer, whereas during cooler temperatures a two salt fluid may be required due to its lower Truce Crystallization Temperature (TCT), i.e., the temperature at which crystalline solids begin to form when cooled. The loss of soluble salts, either by settling out or filtration, will drastically reduce the density of treatment fluid. Loss of density can result is undesirable.

In various embodiments, the aqueous composition has a density of greater than about 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, or 11.5, and up to about 20, ppg. In other embodiments, the aqueous composition has a density of less than about 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, or 9.5, ppg. Viscosity is typically measured via rotational viscometry, also called rotational shear rheometry, in particular using a temperature-controlled rheometer in a cone-and-bob configuration able to measure viscosity as a function of shear rate and temperature under any pressure from 1 bar to 100 bar as desired. The viscosity may be measured at any temperature chosen by one of skill in the art, e.g. at room temperature. In various non-limiting embodiments, all values and ranges of values including and between those set forth above are expressly contemplated for use herein.

### Additional Embodiments

In various embodiments, the surfactant composition does not undergo phase separation over extended periods of time and exhibits high heat stability. In other embodiments, the surfactant composition and aqueous compositions are useful as a fracturing fluid, e.g. in a method of fracturing a subterranean formation. Such fluids create channels or fractures in oil producing reservoir zones in order to improve oil production by providing a high permeability pathway from the reservoir rock to the well bore. Typically, in low permeability zones, fracturing fluids are pumped at pressures exceeding the overburden weight of the rock formation thereby causing splits and fractures in the formation rock. Propping agents (e.g. particulate matter) are added to the fluid to prevent the induced fractures from closing after the pumping phase is over by propping open the induced splits and fractures. Gelling agents can be added to the surfactant composition and/or aqueous composition to transport such propping agents and to reduce fluid leakoff. In higher permeability zones, different methods may be used, but fluid thickeners are often utilized.

The surfactant compositions and aqueous compositions described herein provide several advantages. For example, the surfactant compositions and aqueous compositions when used for downhole fluid produce less residue on the formation which could result in formation damage during and after the downhole process. Also, it is easier to prepare the surfactant compositions and aqueous compositions as compared with polymers which typically must be hydrated. Moreover, the surfactant compositions and aqueous compositions can be designed to “break” with formation temperatures or other factors such as oxidizers or acids. One can also “break” the gelled fluids and/or aqueous compositions by using solvents such as hydrocarbons, alcohols, or even produced oil from the formation. The surfactant compositions and/or aqueous compositions are useable over a wide range of temperature depending on chain length, and can assist in removing oil from the formation.

For purposes of selectively modifying the permeability of underground rock formations, the surfactant compositions can first be blended with water and different types and amounts of inorganic and organic salts to form the aqueous composition described above. This aqueous composition may then be injected into a rock formation in an amount effective to reduce the permeability of the more permeable zone(s) of the formation. The concentration of the surfactant composition in the aqueous composition can be from about 0.5% to about 10%, typically from about 2% to about 8%, and more typically from about 3% to about 5% by weight. In various non-limiting embodiments, all values and ranges of values including and between those set forth above are expressly contemplated for use herein.

A major portion of the world's hydrocarbon reserves are found in carbonate rock structures which are known to have very low permeability. In many sandstone reservoirs, the rock structure may be cemented together by carbonate, or carbonate scales may accumulate close to production wells as a result of carbon dioxide being released from solution due to a pressure drop. Another type of scale that can accumulate around production wells is iron scale, in particular iron oxides and hydroxides. Low permeability, drilling damage and accumulation of scale all impede the flow of oil to the production well and the conventional method used to open up channels around the well bore to improve the flow rate is the injection of acid known as acidizing or acid stimulation. Accordingly, this disclosure also contemplates an aqueous, acid thickened composition comprising one or more of the aforementioned surfactant compositions and acid. Such thickened acid compositions can be described as gels and can be advantageously employed as an acidizing fluid.

There are generally two types of acid treatment known in the art: fracture acidizing, i.e., injection of acid at rates above fracture pressure to etch the faces of the resultant fractures and matrix acidizing where the injection of acid is at rates below fracture pressure to dissolve flow channels in the rock or to remove scale or damage caused by drilling. Moreover, this may cause release of divalent ions from the formation resulting which interact with the acidizing fluid thereby raising its viscosity. Acid treatments are employed in all types of oil wells and occasionally in water wells wherein they may be used to open fractures or remove damage in newly drilled wells or to rehabilitate old wells from which production has declined. Acid can be pumped into the well, where it reacts with the calcium carbonate according to the following reaction: CaCO₃+2HCl→CaCl₂+CO₂+H₂O. Calcium chloride (CaCl₂) is highly soluble in water and the acid etches channels in the rock, thus improving the oil or gas flow towards the production well. Hydrochloric acid reacts immediately with carbonate rock and tends to form a few large channels known as “wormholes” through the rock, rather than opening up the pore structure. The acid penetration distance is limited to a few feet at most.

Hydrochloric acid reacts rapidly when contacted with carbonate rock such that reduction of reaction rate to allow the acid to penetrate further into the formation or to react more uniformly around the wellbore may be desired. The reaction of hydrochloric acid may be retarded by gelling the acid in accordance with the present disclosure. Additionally, the acid thickened composition can be used to thicken with calcium carbonate up to about 13-17% at which point phase separation causes rapid thinning.

The aforementioned thickened acid gels are also useful in matrix fracturing where fractures are created by injecting sand suspended in an aqueous fluid (known as a proppant) into a well at a rate above fracture pressure. When the injection pressure is removed, the sand remains in place, propping the fracture open. It is very unusual for a propped fracture subsequently to be treated with hydrochloric acid, since the rapid reaction rate between the acid and the rock may cause collapse of the fracture. However damage may be caused by the filtering out of gels from the proppant suspension on the fracture faces and this can substantially reduce the rate of oil or gas flow into the fracture.

Conventionally, oil wells are drilled vertically down into an oil reservoir and through a payzone of the reservoir. Oil flows into the vertical wellbore. In recent years, the drilling of wells out from the vertical wellbore in a horizontal direction through the reservoir has become widespread. In many cases, horizontal wells have increased hydrocarbon production by several orders of magnitude. The removal of drilling damage caused by accumulation of drilling mud filter cake and fine rock particles from horizontal wells is a very costly process due to the need to use specialist techniques, such as injection of acid through coiled tubing, to avoid corrosion of wellhead equipment and prevent hydrochloric acid being spent before it reaches the far end of the horizontal well. The purpose of an acid treatment or acidizing the formation is to remove formation damage along as much of the hydrocarbon flow path as possible. An effective treatment must therefore remove as much damage as possible along the entire flow path. The compositions of the present disclosure allow maximum penetration of the acid resulting in a more effective treatment.

Finally, when a reservoir has been exhausted due to reduction of natural reservoir pressure, water or carbon dioxide gas may be injected to recover a further percentage of the oil-in-place. Water or gas is injected through a proportion of wells in the reservoir (injector wells), thus pushing the oil towards producer wells. In some reservoirs, the rate of water injection is low and hence the oil production rate is low. Acid treatments utilizing the acid gels of the present disclosure can be employed to increase the injectivity of injector wells. The compositions of this disclosure provide several advantages when used for downhole fluids such as producing less residue on the formation which could result in formation damage during and after the downhole process.

For purposes of selectively modifying the permeability of underground rock formations, one or more compositions of this disclosure can first be blended with an aqueous acid composition of desired strength to form a thickened acidic viscoelastic fluid which can be then injected into the rock formation in an amount effective to modify the permeability of the of the formation. In various embodiments, an amount of the one or more surfactant compositions or compositions in the thickened acidic viscoelastic fluid can be from about 0.5% to about 10%, typically from about 2% to about 8%, and more typically from about 4% to about 6% by weight based on a total weight of the thickened acidic viscoelastic fluid. The one or more compositions may include less than about 1% free fatty acid for optimum performance.

In additional embodiments, this disclosure provides a well stimulation composition comprising from about 0.5 wt % to about 10 wt % of actives of the surfactant composition having a viscosity of from about 10 cP to about 1000 cP with measured at about 20° C. via shear rheometry measurement with a shear rate of 100 s⁻¹.

In one embodiment, the well stimulation composition is a fracturing fluid, matrix acidizing fluid, a completion acidizing fluid, a fracture acidizing fluid, or a damage removal acidizing fluid.

In several additional embodiments, this disclosure provides a well stimulation composition which may include any surfactant composition added to one of several brine compositions. Each resulting aqueous composition can provide viscosities and viscoelastic properties that are appropriate for the oilfield process being employed. Since viscoelasticity in general is a description of viscosity at various shear rates and various temperatures, the key properties can be described in a variety of test conditions. Various attributes may be described by 1) the initial viscosity in centipoise (cP) at about 80° F., 2) the maximum viscosity in cP and the temperature at which that viscosity is attained in degrees f, and 3) the service temperature defined as the point at which the viscosity falls below 100 cP. A viscosity of about 100 cP is one generally accepted threshold above which VES fluids can suspend sand particles or inhibitor rapid flow of fluid in oilwell applications. The so-called service temperature is a generally temperature limit in which the 100 cP viscosity threshold can be maintained. Viscosities greater than 100 cP are considered good as a lower dose of surfactant composition can be used for more economical operation and also improved operation. Likewise, viscosities below 100 cP can be sufficient and corrected by somewhat higher concentrations or the desired operation enabled by the VES fluid will be acceptable for a given operation. The best operation is for a surfactant composition that can work in all aqueous fluids and brines. In various embodiments, it is preferred to have a viscosity from about 70 to about 100 cP, about 100 to about 125 cP, from about 125 to about 150 cP, or greater than about 150 cP. Likewise for the service temperature, in various embodiments it is preferred to have a service temperature from about 150° F. to about 185° F., about 185° F. to about 225° F., about 225° F. to about 250° F., or above about 250° F. In some cases of monovalent brines of NaCl and NaBr, ability to create a viscoelastic brine at ambient temperature of 80 F is preferred. In various embodiments, a preferred viscoelasticity for a monovalent brine is achieved at about 80° F., wherein the service temperature is above about 110° F. and perhaps above about 140° F.

This disclosure also provides an acidizing fluid comprising at least one acid and the surfactant composition present in an amount of at least about 1 weight percent actives based on a total weight of the acidizing fluid. In one embodiment, the at least one acid is chosen from mineral acids, organic acids, and combinations thereof. In another embodiment, the at least one acid is chosen from hydrochloric acid, hydrofluoric acid, acetic acid, formic acid, sulfamic acid, chloroacetic acid, and combinations thereof.

This disclosure also provides a method of acidizing an underground formation, the method comprising the step of injecting the acidizing fluid into the underground formation. In various embodiments, the underground formation is a hydrocarbon reservoir or a water reservoir. In other embodiments, the acidizing fluid is injected into the underground reservoir at a rate at or above a reservoir fracture pressure.

This disclosure also provides an aqueous fracturing fluid comprising: a solvent system comprising water; and the surfactant composition present in an amount of at least about 1 weight percent actives based on a total weight of the aqueous fracturing fluid. In various embodiments, the solvent system further includes from about 16 wt % to about 22 wt % ethanol, and from about 10 wt % to about 16 wt % propylene glycol. Moreover, the solvent system may include from about 15 to about 25 wt % of the water. In other embodiments, a weight to weight ratio of ethanol:water is from about 1:1 to about 1.175:1. In various non-limiting embodiments, all values and ranges of values including and between those set forth above are expressly contemplated for use herein.

This disclosure even further provides a method of fracturing a subterranean formation that defines a wellbore, the method comprising the step of pumping the aqueous fracturing fluid described above through the wellbore and into the subterranean formation at a pressure sufficient to fracture the subterranean formation.

This disclosure also provides a brine composition comprising: water; an alkaline metal salt and/or an alkaline earth metal salt; and the surfactant composition described above.

In various additional embodiments, the disclosure provides a surfactant composition and a brine composition including an alkaline metal salt and/or an alkaline earth metal salt. In other examples, the aqueous composition includes from about 0.05 wt % to about 25 wt % of the surfactant composition based on a total weight of the aqueous composition and the brine composition includes from about 3 to about 50 weight percent of a combination of CaCl₂, CaBr₂, ZnBr₂, MgCl₂, NaCl, and/or NaBr, based on a total weight of the brine composition. In other embodiments, the aqueous composition has a viscosity of from about 10 cP to about 1000 cP measured at a temperature of from about 500 F to about 400° F. via shear rheometry measurement with a shear rate of about 100 s⁻¹. In other embodiments, the aqueous composition includes from about 2 wt % to about 10 wt % of the surfactant composition based on a total weight of the aqueous composition and the brine composition includes from about 3 to about 50 weight percent of a combination of CaCl₂, CaBr₂, ZnBr₂, MgCl₂, NaCl, and/or NaBr, based on a total weight of the brine composition. In other embodiments, the aqueous composition has a viscosity of from about 10 cP to about 1000 cP measured at a temperature of from about 50° F. to about 400° F. via shear rheometry measurement with a shear rate of about 100 s⁻¹. In other embodiments, the aqueous composition further includes at least one acid that is able to generate an additional amount of an alkaline metal salt and/or an alkaline earth metal salt via acid hydrolysis. In other embodiments, the at least one acid is chosen from mineral acids, organic acids, and combinations thereof. In other embodiments, the at least one acid is chosen from hydrochloric acid, hydrofluoric acid, acetic acid, formic acid, sulfamic acid, chloroacetic acid, and combinations thereof. In various non-limiting embodiments, all values and ranges of values including and between those set forth above are expressly contemplated for use herein.

### EXAMPLES

Surfactant compositions were made with varying formulations and chemistries. To a 30 ml vial, ingredients were pre-diluted in an appropriate solvent mixture including propylene glycol, water, and ethanol or propanol. Surfactant compositions of 12 different types were formulated and together with various brine examples listed below were used to make aqueous compositions to be tested as viscoelastic solutions. In this disclosure, the first surfactant type is selected from the following structure (I):

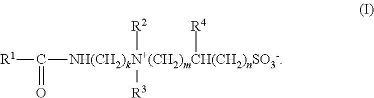

This first surfactant can include for instance the following structure (Z)-3-((3-(docos-13-enamido)propyl)dimethylammonio)-2-hydroxypropane-1-sulfonate, referred to as Surfactant Type (IA), with the following structure:

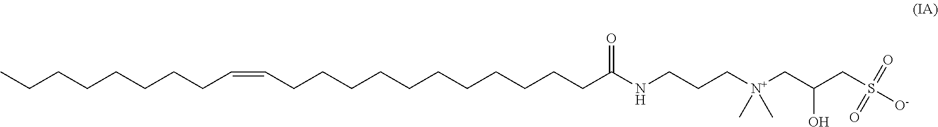 [SMILES: CCCCCCCC/C=C\CCCCCCCCCCCC(=O)NCCC[N+](C)(C)CC(O)CS(=O)(=O)[O-]]

This structure can also more generally be referred to erucamidopropyl hydroxypropylsultaine.

In this disclosure, a second surfactant type is selected from the following structure (II). The second surfactant has the following structure (II):

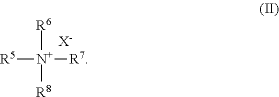

In this structure, R⁵ is an alkyl amine alkylene group, alkyl amido alkylene group, alkyl ether alkylene group, or alkyl ester alkylene group. In one embodiment, R⁵ is an alkyl amine alkylene group. In another embodiment, R⁵ is an alkyl amido alkylene group. In another embodiment, R⁵ is an alkyl ether alkylene group. In another embodiment, R⁵ is an alkyl ester alkylene group. In one such example of second surfactant type, the second surfactant has the following general structure (III):

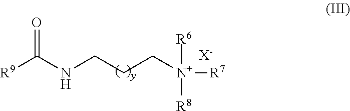

wherein R⁹ is a saturated or unsaturated alkyl group and y is from about 1 to about 12. In various non-limiting embodiments, all values and ranges of values including and between those set forth above are expressly contemplated for use herein. Moreover, in this second surfactant Type II or III, each of R⁶ and R⁷ is independently an alkyl group, a hydroxy alkyl group, a polyalkoxy group having a degree of polymerization of from about 2 to about 30, a hydroxyl alkyl sulfonate group, an alkyl sulfonate group, or an alkylarylsulfonate group. In various embodiments, the degree of polymerization is from about 3 to about 29, about 4 to about 28, about 5 to about 27, about 6 to about 26, about 7 to about 25, about 8 to about 24, about 9 to about 23, about 10 to about 22, about 11 to about 21, about 12 to about 20, about 13 to about 19, about 14 to about 18, about 15 to about 17, or about 16 to about 17. Moreover, R⁸ is a saturated or unsaturated alkyl group, aryl aralkyl group, or alkaryl group. It is also contemplated that any two of R⁶, R⁷ and R⁸, together with the nitrogen atom to which each is attached form a heterocyclic ring that may include 2 to 5 carbon atoms (e.g. 2, 3, 4, or 5 carbon atoms) and 1 to 6 heteroatoms (e.g. 1, 2, 3, 4, 5, or 6 heteroatoms) such as sulfur (S), nitrogen (N), oxygen (O) or silicon (Si) atoms. The number of carbon atoms and/or heteroatoms of any one or more of R⁶, R⁷ and R⁸ may alternatively and independently be as described above relative to R⁵. Similarly, any one or more of R⁶, R⁷ and R⁸ may independently be or include a saturated or unsaturated hydrocarbon group that may be linear, branched, or cyclic and all isomers of such groups are hereby expressly contemplated for use herein in various non-limiting embodiments.

Another type of second surfactant of general structure (III) includes an R⁹ group derived from a natural product rich in erucic acid and referred to by this enriched ingredient. This one surfactant may be referred to by the most predominant combination of species are R9 is erucyl, y is 3, R⁶, R⁷, and R⁸ are methyl and the molecule is called (Z)-3-(docos-13-enamido)-N,N,N-trimethylpropan-1-aminium, referred to as (IIIA), having the following structure:

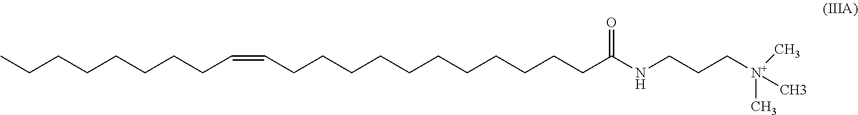 [SMILES: CCCCCCCC/C=C\CCCCCCCCCCCC(=O)NCCC[N+](C)(C)C]

This structure can also more generally be referred to erucamidopropyl trimethyl ammonium with various possible counterions noted, such as chloride.

Comparative examples of both the first surfactant and second surfactant were examined. One second surfactant that presents a comparative example has the following structure (IV):

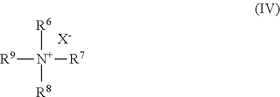

wherein R⁹ is an alkylene group bound directly to a quaternary amine group; which can include an R⁹ group derived from a natural product rich in erucic acid and referred to by this enriched ingredient and R⁶, R⁷, and R⁸ are as described above. One embodiment of these comparative examples may be referred to by the most predominant combination of species where R⁹ is erucyl and R⁶, R⁷, and R⁸ are methyl and the molecule is called (Z)-3-(docos-13-enamido)-N,N,N-trimethylpropan-1-aminium, referred to as (IVA), having the following structure:

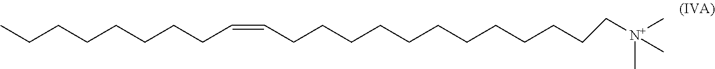 [SMILES: CCCCCCCC/C=C\CCCCCCCCCCCC[N+](C)(C)C]

This structure can also more generally be referred to erucyl trimethyl ammonium with various possible counterions noted, such as chloride.

Alternatively, a second surfactant presenting a comparative example may have general structure (IV) and include an R⁹ group derived from a natural product rich in erucic acid and referred to by this enriched ingredient. This one comparative embodiment may be referred to by the most predominant combination of species where R⁵ is erucyl, R⁶ and R⁷, are hydroxyethyl, and R⁸ is methyl and the molecule is called (Z)—N,N-bis(2-hydroxyethyl)-N-methyldocos-13-en-1-aminium, referred to as (IVB), having the following structure:

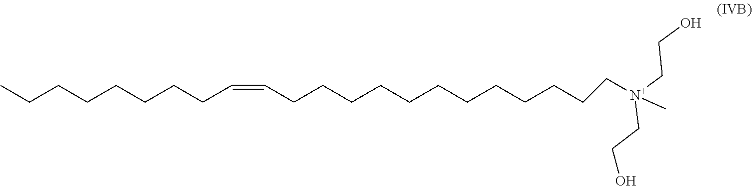 [SMILES: CCCCCCCC/C=C\CCCCCCCCCCCC[N+](C)(CCO)CCO]

This structure can also more generally be referred to erucyl dihydroxyethyl methyl ammonium with various possible counterions noted, such as chloride.

Using the first and second surfactant types described above, 12 Surfactant Composition Examples were created and are shown in Table 1. Each Surfactant Composition Example includes a wt % of Surfactant Type. For completeness, Surfactant Composition Examples 1 includes only the first surfactant and Examples 9 and 10 include a second surfactant, respectively, and are presented as comparative surfactant composition examples. Likewise, when the second surfactant is selected from surfactant type IVA or IVB, this also presents a comparative example as described above.

For Tables 1 and 3 shown below, Surfactant Composition Examples and Aqueous Composition Examples labeled “E” under column “Example Type”, are Inventive Examples. Surfactant Composition Examples and Aqueous Composition Examples labeled “CE” under column “Example Type” are Comparative Examples.

TABLE 1

| | First | First | Second | Second | | Total | |
|---|---|---|---|---|---|---|---|
| | Surfactant | Surfactant | Surfactant | Surfactant | | Surfactant | Example |
| Ex. | Type | wt % | Type | wt % | Ratio | Activity | Type |
| 1 | IA | 42.0% | IIIA | 0.0% | n.a. | 42% | CE |
| | | | | | (infinite) | | |
| 2 | IA | 37.0% | IIIA | 7.4% | 5.00 | 44% | E |
| 3 | IA | 34.6% | IIIA | 11.5% | 3.00 | 46% | E |
| 4 | IA | 33.8% | IIIA | 12.9% | 2.63 | 47% | E |
| 5 | IA | 33.0% | IIIA | 14.3% | 2.31 | 47% | E |
| 6 | IA | 29.8% | IIIA | 19.9% | 1.50 | 50% | E |
| 7 | IA | 26.2% | IIIA | 26.1% | 1.00 | 52% | E |
| 8 | IA | 19.2% | IIIA | 38.3% | 0.50 | 57% | CE |
| 9 | IA | 0.0% | IIIA | 60.8% | 0.00 | 61% | CE |
| 10 | IA | 0.0% | IIIA | 73.0% | 0.00 | 73% | CE |
| 11 | IA | 33.0% | IVA | 14.3% | 0.00 | 47% | CE |
| 12 | IA | 33.0% | IVB | 14.3% | 0.00 | 47% | CE |

In the above, “ratio” refers to a ratio of the First Surfactant to Second Surfactant.

Brines in various concentrations were also made. To a 500 ml stainless steel blender was added a brine solution followed by certain amount (by volume) of varying compositions of this disclosure. The resulting mixtures were stirred for 3 min at an rpm of 3000-4000 in the blender. The resultant gels were then centrifuged at an rpm of 1000 for 15 min to remove air bubbles. Rheological performance was then evaluated using a Grace Instrument Rheometer (model M5600) at constant shear rate of 100 s⁻¹. The rheometer was equipment with a cup/rotor part number MACH5500089 and bob #B5 MACH5500051B. Viscosity is then determined via standard methods based on the cup and bob geometries. A pressure of 400 psi was applied to minimize evaporation of the sample, especially at high temperatures.

Brines of 7 different types were formulated and used to make aqueous compositions with the surfactant compositions. The brine examples are shown in Table 2.

TABLE 2

| | Brine Examples | | | | | | |
|---|---|---|---|---|---|---|---|
| | 1 | 2 | 3 | 4 | 5 | 6 | 7 |
| | Brine Name | | | | | | |
| | | | | 16.5 | | | |
| | | | | ppg | 3% | | |
| | | 14.2 | 15.1 | ZnBr₂/ | CaCl₂/ | | |
| | 30% | ppg | ppg | CaBr₂/ | 3% | 20% | 34% |
| | CaCl₂ | CaBr₂ | ZnBr₂ | CaCl₂ | MgCl₂ | NaCl | NaBr |
| Salt 1 | CaCl₂—2H₂O | | | CaCl₂ | CaCl₂ | | |
| % Salt 1 | 39.73 | | | 12.00 | 3.97 | | |
| Salt 2 | | CaBr₂—xH₂O | | CaBr₂—xH₂O | | | |
| % Salt 2 | | 55.00 | | 38.50 | | | |
| Salt 3 | | | ZnBr₂ | ZnBr₂ | | | |
| % Salt 3 | | | 58.70 | 21.00 | | | |
| Salt 4 | | | | | MgCl₂—6H₂O | | |
| % Salt 4 | | | | | 6.40 | | |
| Salt 5 | | | | | | NaCl | |
| % Salt 5 | | | | | | 20.00 | |
| Salt 6 | | | | | | | NaBr |
| % Salt 6 | | | | | | | 34.00 |
| % Water | 60.27 | 45.00 | 41.30 | 28.85 | 89.63 | 80.00 | 66.00 |

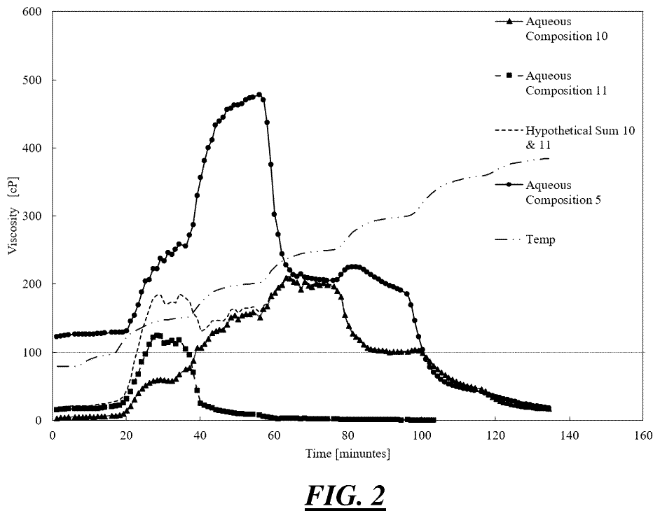

Aqueous Compositions of 34 different types were made by combining the 12 Surfactant Compositions with the 7 brines at various concentrations of the surfactant composition in the brine, noted as concentration in wt %. Also, note that brines where the cation has a charge of +1, such as Na, will be referred to as monovalent brines. Brines where the cation has a charge of +2, such as Ca, Zn, or Mg, will be referred to as divalent brines. A further rating of performance of any example or comparative example is analyzed by extracting data from the rheology plot of viscosity vs time/temperature as shown in FIG. 2, especially for the curve trace labeled Aqueous Composition 5. For each example in Table 3 below, the viscosity at about 80° F. is recorded for the aqueous composition being tested in the Grace M5600 rheometer at a shear rate of 100 s⁻¹. The maximum viscosity in cP and the temperature at which that viscosity is attained in degrees f can also be extracted from traces such as shown in FIG. 2. From traces such as shown in FIG. 2, the following can also be extracted—the service temperature defined here as the point at which the viscosity falls below 100 cP. Thus for each example and comparative examples of FIG. 3, a curve of the relevant rheological data is examined and attributes of the disclosure are shown wherein 1) the initial viscosity is shown in centipoise (cP) at about 80° F., 2) the “Max Viscosity/Temp F” is the maximum viscosity in cP and the temperature at which that viscosity is attained in degrees f, and 3) the service temperature is defined as the point at which the viscosity falls below 100 cP.

It is preferred to have throughout all the regions of interest that include the Initial Viscosity, the Max Viscosity, and the Service Temperature Viscosity, where the viscosity is measured at a shear rate of 100 sec−1 and where viscoelastic viscosity known to those skilled in the art to mean that the viscosity at lower shear rates, such as shear rate of about 5, 10, 15, 20, 25, 30, 40, 50, 60, 70, 80, 90 sec−1 will all demonstrate the viscoelastic effect and exhibit a higher viscosity at these lower shear rates. For the parameters measured here, it is preferred to have viscosity from 70 to 100 cP, more preferred to have viscosity from 100 to 125 cP still more preferred to have viscosity from 125 to 150 cP and most preferred to have viscosity >150 cP, where these preferred viscosity levels refer to Initial and Max Viscosity. By definition, the service temperature viscosity is 100 cP. For Service Temperature, it is preferred to have a service temperature from 150° F. to 185° F., more preferred from 185° F. to 225° F., still more preferred from 225° F. to 250° F., and most preferred above 250° F. In some cases of monovalent brines of NaCl and NaBr, ability to create a viscoelastic brine at ambient temperature of 80° F. is preferred. When a preferred viscoelasticity for a monovalent brine is achieved at about 80° F., it is preferred that the monovalent brine service temperature also be above 110° F. and more preferred that it is above 140° F.

With the preferred levels defined, the viscosity performance can be attributed in the Aqueous Composition Examples of Table 3 and a given a Brine Tolerance Rating where a “+” sign indicates the assessment of ability to provide viscosity benefits that are preferred, more preferred, and most preferred at ambient temperature about 80° F. and also at elevated temperatures above 80° F. A “−” sign in this column indicates the surfactant composition in that particular brine cannot provide a preferred level of viscosity at the ambient temperature of 80° F. or provide a service temperature at elevated temperatures above 100° F. and extending to about 400° F. and other numbers shown in the column labeled “Service Temp F” in Table 3. For the Aqueous Composition Examples 1 to 11, the brine tolerance is held constant as only CaCl₂ brine is examined, thus NA denotes that brine tolerance is “Not Assessed” for these examples, where instead relative performance is assessed on ability to provide viscosity at about 80° F. and 250° F.

By looking at overall brine tolerance rating and the individual viscosity ratings falling within the preferred, more preferred, or most preferred categories, the aqueous compositions are denoted again by Example Type “E” which denotes an Inventive “Example” and “CE” denotes a “Comparative Example”. Thus for instance, Surfactant Composition Example 5 is tested for 7 different brines, with each providing at least preferred viscosity benefits and service temperature, and thus is Overall Brine tolerant and an inventive example of this disclosure.

TABLE 3

| | | | Surfactant | | Initial | Max | | | | |
|---|---|---|---|---|---|---|---|---|---|---|
| Aqueous | | | Composition | Surfactant | Viscosity | Viscosity | Service | Viscosity | Brine | |
| Composition | Brine | Brine | Concentration | Composition | at | cP/Temp | Temp | at | Tolerance | Example |
| Examples | Example | Description | Example | wt % | 80° F. | ° F. | ° F. | 300° F. | Rating | Type |
| 1 | 1 | 30% CaCl₂ | 1 | 6 | 31 | | | 197 | NA | CE |
| 2 | 1 | 30% CaCl₂ | 2 | 6 | 107 | | | 210 | NA | E |
| 3 | 1 | 30% CaCl₂ | 3 | 6 | 111 | | | 192 | NA | E |
| 4 | 1 | 30% CaCl₂ | 4 | 6 | 110 | | | 181 | NA | F |
| 5 | 1 | 30% CaCl₂ | 5 | 6 | 95 | FIG. 2 | | 149 | NA | E |
| 6 | 1 | 30% CaCl₂ | 6 | 6 | 104 | | | 118 | NA | F |
| 7 | 1 | 30% CaCl₂ | 7 | 6 | 109 | | | 85 | NA | E |
| 8 | 1 | 30% CaCl₂ | 8 | 6 | 149 | | | 27 | NA | CE |
| 9 | 1 | 30% CaCl₂ | 9 | 6 | 268 | | | 0.1 | NA | CE |
| 10 | 1 | 30% CaCl₂ | 1 | 4.75 | | FIG. 2 | | | NA | CE |
| 11 | 1 | 30% CaCl₂ | 10 | 1.25 | | FIG. 2 | | | NA | CE |
| 12 | 1 | 30% CaCl₂ | 5 | 6 | 123 | 478/201 | 327 | | + | |
| 13 | 2 | 14.2 ppg | 5 | 6 | 74 | 134/160 | 370 | | + | |
| | | CaBr₂ | | | | | | | | |
| 14 | 3 | 15.1 ppg | 5 | 6 | 209 | 209/78 | 161 | | + | |
| | | ZnBr₂ | | | | | | | | |
| 15 | 4 | 16.5 ppg | 5 | 6 | 216 | 216/79 | 244 | | + | E |
| | | ZnBr₂/CaBr₂/ | | | | | | | | |
| | | CaCl₂ | | | | | | | | |
| 16 | 5 | 3% CaCl₂/3% | 5 | 6 | 182 | 349/148 | ~260 | | + | |
| | | MgCl₂ | | | | | | | | |
| 17 | 6 | 20% NaCl | 5 | 6 | 192 | 197/96 | 115 | | + | |
| 18 | 7 | 34% NaBr | 5 | 6 | 190 | 289/118 | 146 | | + | |
| 19 | 1 | 30% CaCl₂ | 1 | 6 | 31 | 271/260 | 353 | | − | CE |
| 20 | 2 | 14.2 ppg | 1 | 6 | 2 | 23/249 | NA | | − | |
| | | CaBr₂ | | | | | | | | |
| 21 | 3 | 15.1 ppg | 1 | 6 | 18 | 25/108 | NA | | − | |
| | | ZnBr₂ | | | | | | | | |
| 22 | 4 | 16.5 ppg | 1 | 6 | 1 | 1 | NA | | − | |
| | | ZnBr₂/CaBr₂/ | | | | | | | | |
| | | CaCl₂ | | | | | | | | |
| 23 | 5 | 3% CaCl₂/3% | 1 | 6 | 147 | 320/181 | ~260 | | + | |
| | | MgCl₂ | | | | | | | | |
| 24 | 6 | 20% NaCl | 1 | 6 | 151 | 308/151 | 279 | | + | |
| 25 | 7 | 34% NaBr | 1 | 6 | 25 | 246/203 | 303 | | − | |
| 26 | 1 | 30% CaCl₂ | 11 | 6 | 46 | 378/218 | 320 | | − | CE |
| 27 | 2 | 14.2 ppg | 11 | 6 | 0.5 | 87/252 | NA | | − | |
| | | CaBr₂ | | | | | | | | |
| 28 | 3 | 15.1 ppg | 11 | 6 | 82 | 82/77 | NA | | − | |
| | | ZnBr₂ | | | | | | | | |
| 29 | 4 | 16.5 ppg | 11 | 6 | 45 | 54/159 | NA | | − | |
| | | ZnBr₂/CaBr₂/ | | | | | | | | |
| | | CaCl₂ | | | | | | | | |
| 30 | 6 | 20% NaCl | 11 | 6 | 151 | 388/132 | 251 | | + | |
| 31 | 1 | 30% CaCl₂ | 12 | 6 | 296 | 391/100 | 152 | | − | CE |
| 32 | 2 | 14.2 ppg | 12 | 6 | 133 | 377/192 | 338 | | + | |
| | | CaBr₂ | | | | | | | | |
| 33 | 3 | 15.1 ppg | 12 | 6 | 306 | 330/144 | 232 | | + | |
| | | ZnBr₂ | | | | | | | | |
| 34 | 4 | 16.5 ppg | 12 | 6 | 106 | 233/306 | >390 | | + | |
| | | ZnBr₂/CaBr₂/ | | | | | | | | |
| | | CaCl₂ | | | | | | | | |
| 35 | 5 | 3% CaCl₂/3% | 12 | 6 | 103 | 196/193 | 220 | | − | |
| | | MgCl₂ | | | | | | | | |
| 36 | 6 | 20% NaCl | 12 | 6 | 11 | 13/79 | NA | | − | |
| 37 | 7 | 34% NaBr | 12 | 6 | 15 | 26/80 | NA | | − | |

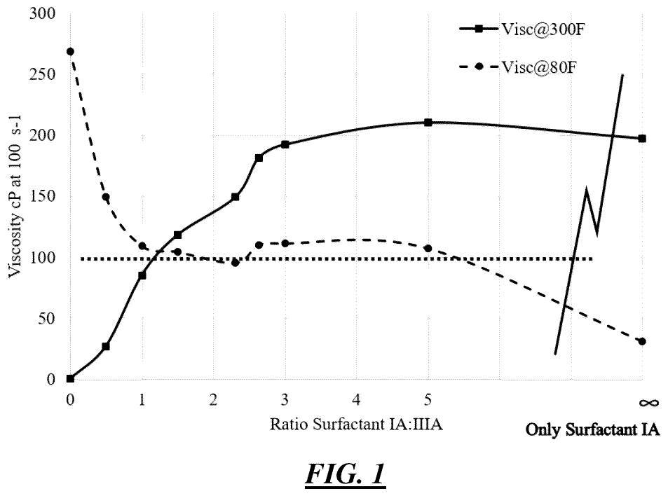

Examples 1 through 9 were made by mixing 6 wt % of each Surfactant Composition Example 1 through 9 in 30 wt % CaCl₂ (Brine Ex 1) to create the 9 Aqueous Composition Examples 1 to 9. From two measurements, including Initial Viscosity at 80° F. as well as Viscosity at 300° F., the change in these viscosities provided by the various compositions vs Surfactant Ratio of Surfactant IA to IIIA is shown (see FIG. 1).

It was demonstrated in the graph of FIG. 1, that various compositions of this disclosure work over a wide range of ratios of Surfactant IA to Surfactant IIIA, where IA can be described as erucamidopropyl hydroxypropylsultaine and IIIA is erucamidopropyl trimethylquaternary ammonium. Both surfactants have net charges that are counterbalanced by sodium and chloride, but these can include any other appropriate counterions such as lithium, potassium, ammonia, rubidium, fluoride, bromide, and others.

FIG. 1 shows a target line of 100 cP of viscosity and two curves, one for viscosity at 78° F. and one at 300° F. Various compositions can work at temperatures over this entire range. FIG. 1 shows that neat erucamidopropyl hydroxypropylsultaine in the noted CaCl₂ brine and neat erucamidopropyl trimethyl ammonium chloride do not provide viscosity near or above 100 CP at work at 80° F. or 250° F. Over the range of Surfactant IA to IIIA ratios of 1 to 5, the Aqueous Composition Examples work well and meet the preferred viscosity range of about 70 cP or greater. Over the range of Surfactant IA to IIIA ratios of 1.0 to 5, the Aqueous Composition Examples work well and meet the even more preferred viscosity range of about 100 cP or greater.

A further example was evaluated to show the viscosity during constant shearing at a rate of 100 s−1 and while a temperature is increased gradually from −70° F. to about 400° F. The results are set forth in FIG. 2.

FIG. 2 shows four traces wherein a 6 wt % dose of surfactant is broken down into 4 traces.

A first trace includes addition of 4.75 wt % of Surfactant Composition Example 1 erucamidopropyl hydroxypropylsultaine in 30% CaCl₂ Brine Example 1 to form Aqueous Composition 10. This is representative of an embodiment of the first surfactant IA of this disclosure.

A second trace includes addition of 1.25 wt % of Surfactant Composition Example 10 erucamidopropyl trimethylquaternary ammonium in 30% CaCl₂ Brine Example 1 to form Aqueous Composition 11. This is representative of an embodiment of the second surfactant IIIA of this disclosure in CaCl₂ brine at 1.25 wt %.

A third trace includes hypothetical addition of the aforementioned two compounds with a dashed line assuming no interaction or synergy.

A fourth trace include the actual performance of the aforementioned two compounds in a combined total of 6 wt % of Surfactant Composition Example 5 in CaCl₂ brine to form the Aqueous Composition Example 5, which is equivalent to the combined addition of Surfactant Composition Examples 1 and 11 at the above mentioned additions of 4.75 wt % and 1.25 wt %, respectively. This trace is representative of an embodiment of the combined surfactant composition of this disclosure including First Surfactant Type IA and Second Surfactant Type IIIA with a ratio of 2.31:1.

FIG. 2 shows that the Aqueous Composition Example 5 shows a tremendous increase in viscosity even at about 80° F. to 120 cP, as compared to the individual contributions of either of the compositions made from individual surfactants, or their theoretical combination, which have viscosity of only about 20 cP. FIG. 2 also shows Aqueous Composition 5 has an impressive increase in viscosity at both the maximum performance temperature of about 200° F. of about 480 cP and also a higher viscosity of at least above 180 to 200 cP until the maximum service temperature at 300° F. drops below 100 cP. In all cases, the target for sufficient viscosity of preferred level of 70 cP and the more preferred level of at least 100 cP at 100 s−1 is met. In FIG. 2, the Y-axis is also for Temperature of the solution in degrees fahrenheit.

The performance of the inventive and comparative Aqueous Compositions Examples 12 through 37 are shown in Table 3. These examples include systematic evaluation of a key inventive Surfactant Composition Example 5 in all exemplified Brine Examples (1 through 7) at a standard of 6 wt %. The weight percent can of course be modified to give greater or lesser viscosity performance for the inventive example as desired.

The Aqueous Composition Examples 12 through 18 include 6 wt % of inventive Surfactant Composition Example 5 in aqueous brines with Brine 1 including 30 wt % CaCl₂, Brine 2 including 14.2 ppg CaBr₂, Brine 3 including 15.1 ppg ZnBr₂, Brine 4 including 16.5 ppg ZnBr₂/CaBr₂/CaCl₂, Brine 5 including 3% CaCl₂ and 3% MgCl₂, Brine 6 including 20% NaCl, and Brine 7 including 34% NaBr. The weight compositions of each brine are given in Table 2. In Table 3, for Aqueous Examples 12 to 18, it is seen that for each case, the Initial and Max viscosities are preferred for all cases and are more preferred for all cases but Example 13. Likewise, for these Aqueous Composition Examples 12 through 18, the Service Temperature for all divalent brines is more or most preferred. This performance trend is noted with + signs in the column of Table 3 labeled “Brine Performance Rating” and the column labeled “Example Type” is labeled “E”, indicated that this inventive Surfactant Composition exhibits broad brine tolerance about all tested brines.

The Comparative Aqueous Compositions 19 through 25 include 6 wt % of the comparative Surfactant Composition Example 1, including only Surfactant Composition 1 (Type IA without a co-surfactant). These examples do not exhibit preferred initial viscosities for Brines 1, 2, 3, or 4. This emphasizes the inventive benefit of a surfactant blend such as in Surfactant Composition 5. This performance trend is noted with “−” signs under Table 3 “Brine Performance Rating” and the Example Type is noted as CE for comparative example showing the lack of performance for initial viscosity. This represents a clear example of how the use of the individual comparative surfactant is inferior to the Surfactant Composition 5 including 2.31:1 ratio of Surfactant IA and IIIA in the current disclosure.

The Comparative Aqueous Compositions 26 through 30 include 6 wt % of the comparative Surfactant Composition Example 11, which includes a mixture of first surfactant Type IA together with second surfactant Type IVA, a comparative combination. These Aqueous Compositions 26 to 30 do not exhibit preferred initial viscosities for Brines 1, 2, 3, or 4. This performance trend is noted with “−” signs under Table 3 “Brine Performance Rating” and the Example Type is noted as CE for comparative example showing the lack of performance for initial viscosity. This shows the deficit of the comparative examples to provide the initial ambient viscoelastic effect and viscosity needed for many oilfield applications noted in the specification. In addition for Brines 2, 3 and 4, it is noted that these comparative aqueous composition examples do not ever exceed 100 cP and thus have no defined service temperature.

Comparative Aqueous Compositions 31 through 37 include 6 wt % of the comparative Surfactant Composition Example 12, which itself includes a mixture of first surfactant Type IA together with second surfactant Type IVB, a comparative combination. These Aqueous Compositions 31 to 37 exhibit better performance in the divalent Brines 1, 2, 3, and 4 than the Comparative Examples 26 to 30, however, in this case the performance in monovalent brine 6 and 7 is very poor at less than 30 cP at 80° F. They thus do not perform across a wide variety of mono and divalent brines. This performance trend is noted with “−” signs under Table 3 “Brine Performance Rating” and the Example Type is noted as CE for comparative example showing the lack of performance for initial viscosity. This shows again the deficit of the comparative examples to provide the initial ambient viscoelastic effect and viscosity needed for many oilfield applications in a variety of brine types as noted in the specification. In addition, for Brines 1, the important case of CaCl₂ brine, it is noted that this Surfactant Composition 12 greatly reduces the service temperature from 327° F. to 152° F., another comparative example showing poor performance of the comparative examples.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A surfactant composition comprising:
A. a first surfactant having the following structure (I): 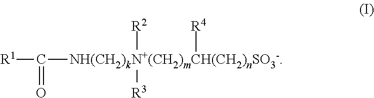
wherein R¹ is a saturated or unsaturated hydrocarbon group having from about 17 to about 29 carbon atoms,
wherein each of R² and R³ is independently a straight chain or branched, alkyl or hydroxyalkyl, group having from 1 to about 6 carbon atoms,
wherein R⁴ is chosen from H, a hydroxyl group, an alkyl group, and a hydroxyalkyl group, each group having from 1 to about 4 carbon atoms;
wherein k is from about 2 to about 20, m is from about 1 to about 20, and n is from about zero up to about 20; and
B. a second surfactant having the following structure (II): 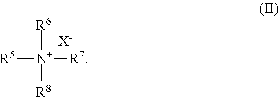
wherein R⁵ is an alkyl amine alkylene group, alkyl amido alkylene group, alkyl ether alkylene group, or alkyl ester alkylene group;
wherein each of R⁶ and R⁷ is independently an alkyl group, a hydroxy alkyl group, a polyalkoxy group having a degree of polymerization of from about 2 to about 30, a hydroxyl alkyl sulfonate group, an alkyl sulfonate group, or an alkylarylsulfonate group;
wherein R⁸ is a saturated or unsaturated alkyl group, aryl aralkyl group, or alkaryl group; or
wherein any two of R⁶, R⁷ and R⁸, together with the nitrogen atom to which each is attached form a heterocyclic ring; and
wherein X is chosen from halides, oxo ions of phosphorus, sulfur, or chloride, and organic anions.

2. The surfactant composition of claim 1 wherein said second surfactant has the following general structure (III): 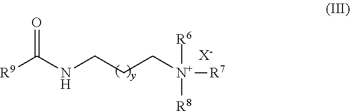
wherein R⁹ is a saturated or unsaturated alkyl group and y is from about 1 to about 12.

3. The surfactant composition of claim 1 wherein said second surfactant is:

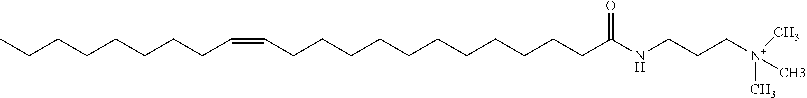 [SMILES: CCCCCCCC/C=C\CCCCCCCCCCCC(=O)NCCC[N+](C)(C)C]

4. The surfactant composition of claim 1 wherein R¹ is a C₂₂ group, each of R², R³, and R⁴ are methyl groups, and k is about 3.

5. The surfactant composition of claim 1 wherein the ratio of the weight percent of the said first surfactant to the weight percent of the second surfactant is from greater than about 0.5 and up to about 10.

6. The surfactant composition of claim 1 wherein the ratio of the weight percent of the said first surfactant to the weight percent of the second surfactant is from greater than about than 1.5 and up to about 5.

7. The surfactant composition of claim 1 wherein said first surfactant is present in an amount of from about 25 to about 70 weight percent actives based on a total weight of said surfactant composition and said second surfactant is present in an amount of from about 5 to about 30 weight percent actives based on a total weight of said surfactant composition.

8. The surfactant composition of claim 1 wherein said first surfactant is present in an amount of from about 25 to about 50 weight percent actives based on a total weight of said surfactant composition and said second surfactant is present in an amount of from about 7 to about 27 weight percent actives based on a total weight of said surfactant composition.

9. The surfactant composition of claim 1 wherein said first surfactant is present in an amount of from about 20 to about 40 weight percent, the second surfactant is present in an amount of from about 3 to about 40 weight percent, ethanol and isopropanol are optionally present in an amount of from about 15 to about 25 weight percent, propylene glycol is optionally present in an amount of from about 10 to about 16 weight percent, and water is optionally present in an amount of from about 1 to about 5 weight percent, each based on a total weight of said composition.

10. An aqueous composition comprising said surfactant composition of claim 1 and a brine composition comprising an alkaline metal salt and/or an alkaline earth metal salt.

11. The aqueous composition of claim 10 comprising from about 0.05 wt % to about 25 wt % of said surfactant composition based on a total weight of said aqueous composition and wherein said brine composition comprises from about 3 to about 50 weight percent of a combination of CaCl2, CaBr2, ZnBr2, MgCl2, NaCl, and/or NaBr, based on a total weight of said brine composition.

12. The aqueous composition of claim 11 having a viscosity of from about 10 cP to about 1000 cP measured at a temperature of from about 50° F. to about 400° F. via shear rheometry measurement with a shear rate of about 100 s⁻¹.

13. An aqueous composition of claim 10 comprising from about 2 wt % to about 10 wt % of said surfactant composition based on a total weight of said aqueous composition and wherein said brine composition comprises from about 3 to about 50 weight percent of a combination of CaCl2, CaBr2, ZnBr2, MgCl2, NaCl, and/or NaBr, based on a total weight of said brine composition.

14. The aqueous composition of claim 13 having a viscosity of from about 10 cP to about 1000 cP measured at a temperature of from about 50° F. to about 400° F. via shear rheometry measurement with a shear rate of about 100 s⁴.

15. The aqueous composition of claim 10 further comprising at least one acid generates an additional amount of an alkaline metal salt and/or an alkaline earth metal salt via acid hydrolysis.

16. The aqueous composition of claim 15 wherein said at least one acid is chosen from mineral acids, organic acids, and combinations thereof.

17. The aqueous composition of claim 15 wherein said at least one acid is chosen from hydrochloric acid, hydrofluoric acid, acetic acid, formic acid, sulfamic acid, chloroacetic acid, and combinations thereof.

18. A method comprising the step of adding the aqueous composition of claim 10 to an underground formation.

19. The method of claim 18 wherein the underground formation is a hydrocarbon reservoir or a water reservoir and the step of adding is further defined as injecting the aqueous composition at a rate at or above a reservoir fracture pressure.

20. The method of claim 18 wherein the step of adding is further defined as pumping the aqueous composition through a wellbore and into the subterranean formation at a pressure sufficient to fracture the subterranean formation.
